(19) United States
(12) Patent Application Publication
(10) Pub. No.: US 2016/0132893 A1
(43) Pub. Date: May 12, 2016

(54) SYSTEM AND METHOD FOR RETURNED GOODS MANAGEMENT

(71) Applicants: Donald Lee Bisges, Acworth, GA (US); John Gerard Bisges, Buford, GA (US)

(72) Inventors: Donald Lee Bisges, Acworth, GA (US); John Gerard Bisges, Buford, GA (US)

(21) Appl. No.: 14/874,081

(22) Filed: Oct. 2, 2015

Related U.S. Application Data
(60) Provisional application No. 62/078,718, filed on Nov. 12, 2014.

(51) Int. Cl. G06Q 30/00

(52) U.S. Cl. CPC G06Q 30/016

(57) ABSTRACT

A solution for centralized management of returned goods transactions is described. The solution may receive a returned good content that comprises a picture of a returned good. From the picture, the returned good may be categorized as one of a repairable item or an item that should be scrapped. A centralized database may be kept for the purpose of tracking the repair or scrap of the returned good and documenting various events and data associated with the returned good. From the database, a returned goods report that is useful for indicating a chargeback amount owed a retailer for losses associated with one or more returned goods over a period of time may be generated. Advantageously, because the solution herein is centralized between a retailer and a supplier, a transparent and accurate accounting of chargeback amounts may be provided to both the retailer and the supplier.

### CROSS-REFERENCE TO RELATED APPLICATIONS

This claims priority under 35 U.S.C. §119(e) to U.S. provisional application filed on Nov. 12, 2014 under attorney docket number 511190156 and assigned application Ser. No. 62/078,718, the entire contents of which are hereby incorporated by reference.

### BACKGROUND

Cost effective and accurate management of defective merchandise, whether such defective merchandise languishes in inventory or is returned by a customer, is a ubiquitous goal of suppliers and retailers across market segments. Current systems and methods for handling defective merchandise, however, leave much room for improvement.

Ideally, when a retailer finds itself with a defective item, it will notify the supplier of the item and “work with” the supplier to follow its dispensation instructions. In reality, however, current systems and methods create an incentive for a retailer, or its employees perhaps, to simply scrap otherwise repairable goods and/or replace customer-returned goods “no questions asked” with new merchandise. The retailer is naturally motivated to minimize its use of warehousing space for defective items, keep its repair and assembly labor costs down, and generally limit any expense that does not directly contribute to end user sales. Consequently, it is no wonder that retailers are generally bent towards scrapping defective items, especially considering that the lost value of the scrapped goods may be charged back to the supplier.

From the supplier's point of view, if a defective item could be repaired in lieu of being scrapped then doing so may be a more desirable course of action. Moreover, if the scrapping of otherwise repairable goods is minimized, suppliers recognize that the average cost of the good may also be minimized. Further, under current systems and methods, justification of chargeback amounts inevitably strain business relationships between suppliers and retailers.

Therefore, what is needed is a system and method for management of returned goods that efficiently identifies cost-effectively repairable goods, facilitates repair of such goods, and transparently accounts for chargeback transactions between a supplier and retailer.

### SUMMARY OF THE DISCLOSURE

A method and system are described for centralized management of returned goods transactions. An exemplary embodiment includes receiving a returned good content that comprises a picture of a returned good. From the picture, the returned good may be categorized as one of a repairable item or an item that should be scrapped. If the returned good is repairable, the exemplary embodiment may, among other actions, generate a parts list for repair of the item, generate a shipping label for shipment of the parts list, and generate a tracking number. If the returned good is designated for scrap, the exemplary embodiment may generate dispensation instructions including, but not limited to, a returned goods authorization number. The exemplary embodiment may further update a centralized database for the purpose of tracking the repair or scrap of the returned good and documenting the various events and data (such as customer data from a receipt) associated with the returned good. Moreover, the exemplary embodiment may include generating a returned goods report that is useful for indicating a chargeback amount owed a retailer for losses associated with one or more returned goods over a period of time. Advantageously, because the solution herein is centralized between a retailer and a supplier, a transparent and accurate accounting of chargeback amounts may be provided to both the retailer and the supplier. Also, because the solution herein is centralized between a retailer and a supplier, a supplier may work with a retailer to mitigate an eventual chargeback amount. Moreover, because the solution herein is centralized between a retailer and a supplier, customer follow-up efforts may be efficiently allocated between a supplier and retailer. And, because the solution herein is centralized between a retailer and a supplier, customer data and history may be easily shared between a retailer and supplier.

### BRIEF DESCRIPTION OF THE DRAWINGS

In the Figures, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a functional block diagram illustrating exemplary components of a system for managing returned goods from a merchant retail location;

FIG. 1B is a functional block diagram illustrating exemplary components of a system for managing returned goods from a customer location;

FIG. 2 is a diagram of an exemplary, non-limiting aspect of a portable computing device (“PCD”) comprising a wireless tablet or telephone which corresponds with FIG. 1;

FIG. 3 is a functional block diagram of a general purpose computer that may form at least one of the merchant inventory management and accounting system, supplier inventory management and accounting system, and Bizzap server illustrated in FIG. 1;

FIG. 4 is a product and communications flow diagram associated with a prior art system and method for management of returned goods; and

FIGS. 5A-5C is a product and communications flow diagram illustrating various aspects of a system and method for management of returned goods according to an exemplary embodiment of the solution.

### DETAILED DESCRIPTION

The word “exemplary” is used herein to mean “serving as an example, instance, or illustration.” Any aspect described herein as “exemplary” is not necessarily to be construed as preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed. Further, an “application” may be a complete program, a module, a routine, a library function, a driver, etc.

The term “content” may also include files having executable content, such as: object code, scripts, byte code, markup language files, and patches. In addition, “content” referred to herein, may also include files that are not executable in nature, such as documents that may need to be opened or other data files that need to be accessed, transmitted or rendered. For example, in this description, reference to “returned goods content” may include any, or all of, but not limited to, a picture of a returned good, a proof of purchase (e.g., scan of a barcode, scan of a QR code, an optical character recognition file of a receipt, etc.), customer contact information, returned goods authorization number, etc.

In this description, the term “QR code” is used generally to refer to any type of matrix barcode (or multi-dimensional bar code) or identifier associated with a returned goods transaction and is not meant to limit the scope of any embodiment to the use of the specific type of barcode understood in the art to be a quick response code. That is, it is envisioned that any given embodiment of the systems and methods within the scope of this disclosure may use data identifiable in the form of barcodes, plain text user entries, NFC transmissions, WiFi transmissions, short wave radio transmissions (e.g., Bluetooth), light modulations, sound modulations. etc. Moreover, as one of ordinary skill in the art understands, a matrix barcode is an optical machine-readable label that may be associated with data such as data representative of a returned good or a damaged good in inventory. An exemplary matrix barcode may include black modules (square dots) arranged in a square grid on a white background. The information encoded by the barcode may be comprised of four standardized types of data (numeric, alphanumeric, byte/binary, Kanji) or, through supported extensions, virtually any type of data. As one of ordinary skill in the art further understands, a matrix barcode may be read by an imaging device, such as a camera, and formatted algorithmically by underlying software using error correction algorithms until the image can be appropriately interpreted. Data represented by the barcode may then be extracted from patterns present in both horizontal and vertical components of the image.

In this description, the terms “item,” “good” and “merchandise” are used interchangeably. Also in this description, the terms “customer,” “consumer” and “end user” are used interchangeably to refer to a person or entity other than a retailer who has purchased a good. Similarly, the terms “merchant” and “retailer” are used interchangeably to refer to an entity that markets and sells goods to an end user. And, the terms “supplier” and “manufacturer” are used interchangeably to refer to an entity that provides goods to a retailer for sale to end users.

In this description, the term “returned good” will be understood to capture both goods (e.g., damaged goods) that have been returned to a retailer by a consumer and goods that have been received by a retailer from a supplier. Moreover, the terms “goods,” “items,” “products,” “merchandise” and the like are used interchangeably.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component.

One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “communication device,” “wireless device,” “wireless telephone,” “wireless communication device,” “wireless handset” and portable computing device (“PCD”) are used interchangeably. With the advent of third generation (“3G”) and fourth generation (“4G”) wireless technology, greater bandwidth availability has enabled more portable computing devices with a greater variety of wireless capabilities. Therefore, a portable computing device (“PCD”) may include a cellular telephone, a pager, a PDA, a smartphone, a navigation device, a tablet personal computer (“PC”), or a hand-held computer with a wireless connection or link.

Embodiments of the systems and methods provide for efficient management of a returned goods process. A “Bizzap” server in communication with both a retailer inventory management and accounting system and a manufacturer inventory management and accounting system, and optionally a consumer PCD, centrally documents and reconciles returned goods transactions. By doing so, embodiments of the solution work to minimize unnecessary scrapping of damaged goods otherwise eligible for cost effective repair. Moreover, embodiments of the solution enable accurate accounting of returned goods chargebacks from a retailer to a supplier. Further, embodiments of the solution provide a manufacturer with a channel for direct interaction with a consumer that may enable the manufacturer to repair damaged goodwill resulting from a less than satisfying product experience.

An exemplary embodiment of the solution leverages a tablet-based application configured to communicate with back end hardware/software to manage captured return goods content. Advantageously, embodiments automate the return or repair process of an item from the consumer to the retailer to the manufacturer, keeping all interested parties “in the loop.” In some embodiments, however, it is provided for a consumer to process returns and requests for damaged parts directly with the manufacturer.

By capturing returned goods content in the manner envisioned, embodiments of the solution enable a retailer and a manufacturer to immediately access and share common data associated with a particular good purchased and returned by a particular consumer. Embodiments of the solution provide for, among other functionality:
a) automating the selection of the appropriate item to be returned or repaired/replaced via barcode or QR code scanning, point and touch image selection, and/or product search features;
b) generation of an associated return authorization number from the manufacturer;
c) automating appropriate dispensation instructions from the manufacturer to the retailer or end consumer for a returned good (i.e., a defective product);
d) documentation via actual photo of returned good;
e) generation of shipping label and tracking information viewable to all parties for either replacement parts to the consumer directly or retailer for repairs, or to track the defective product to the manufacturer;
f) reporting to the retailer and manufacturer to provide analytics and business intelligence data for the manufacturer and retailer including, but not limited to, common returns and repair histories to facilitate engineering or product changes; data to more accurately calculate end of year chargebacks for returns; returns by product, manufacturer, geographic area, cost and final dispensation; actual cost of returns per vendor and/or per product to produce a true running total of RGD (Returned Goods); customer information for customers who experienced defective items for promos to rejuvenate the manufacturer brand reputation; manufacturing defect information including photos of defective product to assist in reengineering of product, etc.

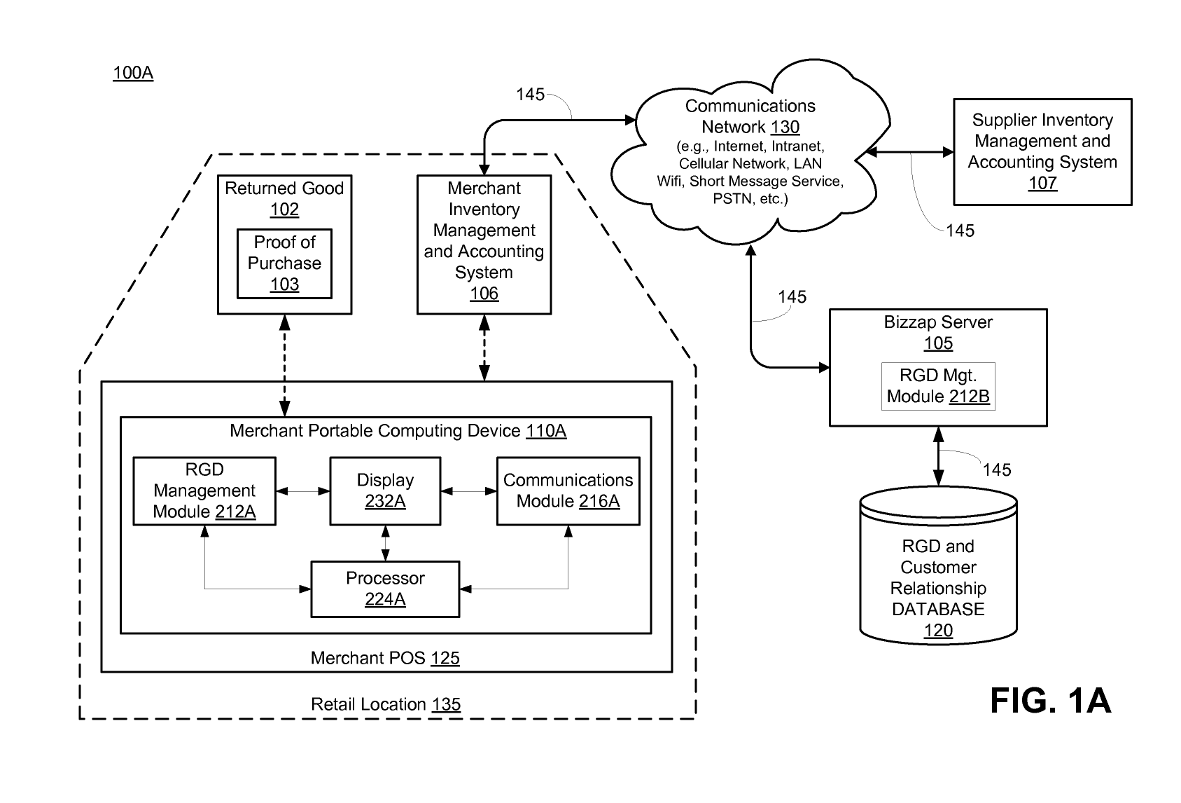

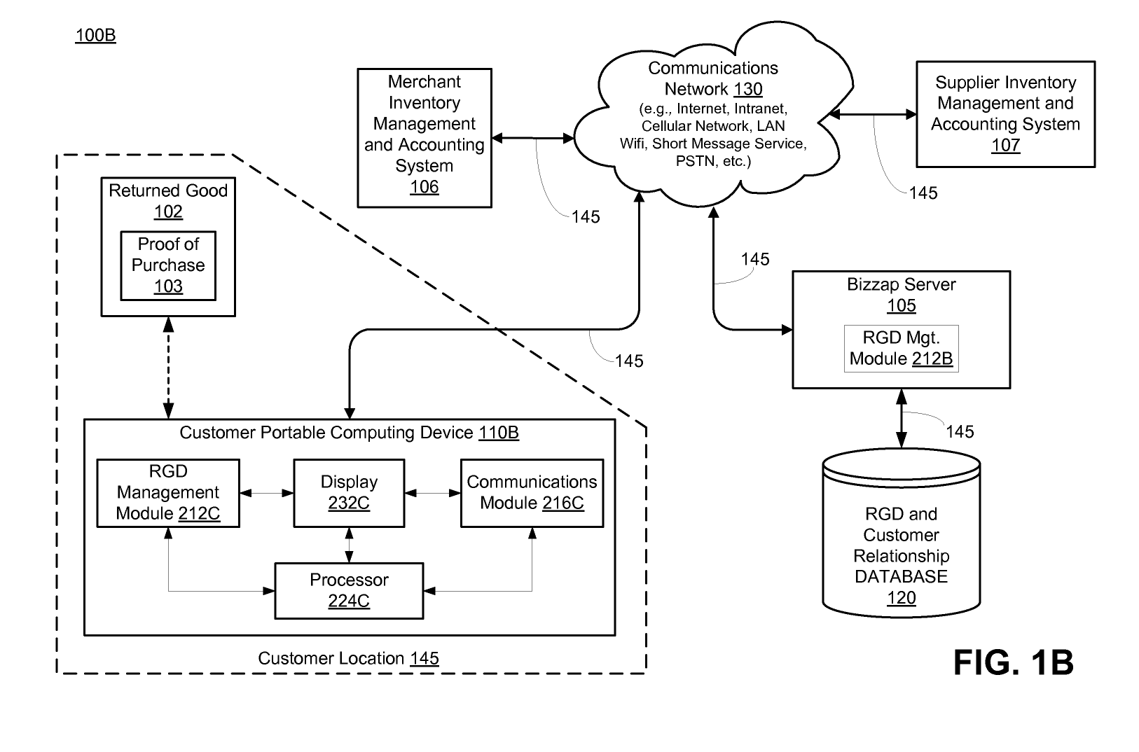

FIG. 1A is a functional block diagram illustrating exemplary components of a system 100A for managing returned goods 102 from a merchant retail location 135. Embodiments of a system 100 for managing returned goods from a merchant retail location and/or a customer location (FIG. 1B) has many potential advantages.

To provide the basis for an exemplary, non-limiting application scenario in which aspects of some embodiments of the disclosed systems and methods may be suitably described, consider a supplier of bicycles to a retailer. Any one or more of the bicycles manufactured by the supplier and shipped to the retailer may be damaged and unsuitable for resale to a customer of the retailer. For example, a given bicycle may have a bent handlebar. In the event that the bent handlebar is discovered by the retailer before the bike is sold to a customer, the retailer may either repair/replace the handlebar or scrap the entire bicycle. Similarly, in the event that the bent handlebar is discovered by a customer who bought the given bicycle from the retailer, the customer may either return the bicycle to the retailer for repair/replacement or work directly with the manufacturer of the bicycle to repair or replace in kind

Returning to the FIG. 1A illustration, a returned good 102 (such as the exemplary bicycle with a damaged handlebar) and an associated proof of purchase 103 or other information uniquely associated with the returned good 102 (e.g., a serial number, an invoice or PO number, etc.) may be presented to the retailer at the retailer location 135. Notably, in the FIG. 1A illustration, it will be understood that the returned good 102 may be merchandise that was bought by an end user and is being returned to the retailer or may be damaged merchandise that has been received by the retailer from the supplier but not yet sold to a customer. Regardless, returned good 102 represents potentially repairable product that, if scrapped, would unnecessarily contribute to a future chargeback transaction between the retailer and supplier.

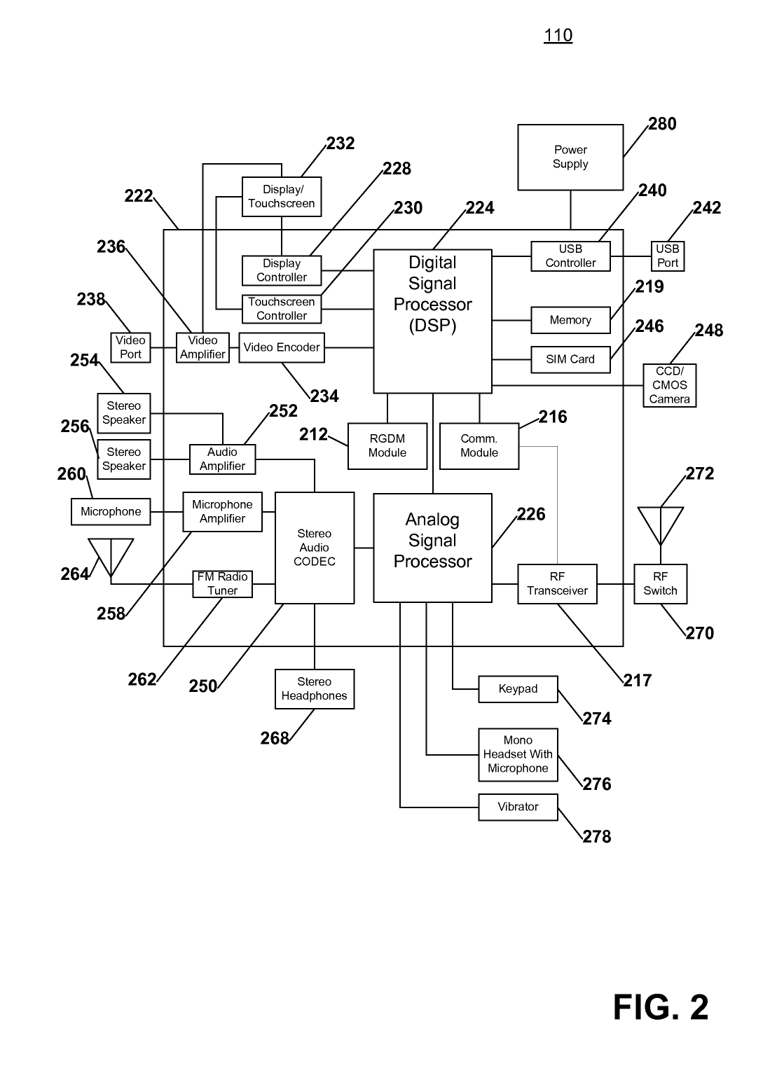

The merchant portable computing device 110A (more detail in FIG. 2 illustration and related description regarding PCD 110) may form part of a merchant point of sale (“POS”) system 125 and be equipped with, among other components and functionality, a returned goods management (“RGDM”) module 212A, a display 232A, a communications module 216A and a processor 224A. Using the RGDM module 212A, the merchant PCD 110A may capture a digital picture of the returned good 102 that documents the type of returned good 102 and the nature of damage to the returned good 102. The RGDM module 212A may also be configured to receive proof of purchase data 103 (such as may be represented by a QR code) for uniquely identifying the customer and/or the good itself.

Using the proof of purchase data 103 and/or the digital picture of the returned good 102, embodiments of the solution may provide for a user of the merchant PCD 110A to interface with a merchant inventory management and accounting (IM&A) system 106 to verify an identification of the returned good 102. For example, the merchant PCD 110A may render pictures of products and models sold by the retailer so that the user of the PCD 110A may match the returned good 102 thereto.

Depending on embodiment, the user of the merchant PCD 110A may make a judgment call as to whether the returned good 102 should be scrapped or repaired. In other embodiments, the system 100A may be preconfigured to dictate to the user of merchant PCD 110A whether the returned good 102 should be designated for scrap of repair. In some embodiments, the supplier may review the returned goods content and return instructions to the retailer regarding scrapping or repairing the returned good. Regardless, in the event that the returned good 102 is designated for repair, the user of the merchant PCD 110A may query merchant IM&A system 106 for a necessary part, or engage the supplier to provide the necessary part, and subsequently coordinate the repair of the returned good. Working through the Bizzap server 105, the user of the merchant PCD 110A may trigger provision of a returned goods authorization (“RGA”) from the supplier IM&A system 107 for return of the damaged good to the supplier. A replacement good (not depicted in FIG. 1) may be pulled from the retailer inventory and provided to a customer in exchange for a returned good 102. Alternatively, a returned good 102 may be repaired and placed in inventory or given back to a customer, depending on the scenario. Regardless, all returned good content is managed through and documented by the Bizzap server 105, thereby aggregating an accurate and multi-party accessible accounting in database 120 of returned goods over a period of time.

Advantageously, the data captured by the merchant PCD 110A in association with the returned good may be transmitted to the Bizzap server 105 via communications network 130. In turn, the Bizzap server 105 may leverage RGDM module 212B to interface with the RGDM module 212A to store the returned good transaction data in the RGD and Customer Relationship database 120. As such, an accurate accounting of the returned goods over a period of time may be accessed by, and provided to, both of the retailer and supplier. In this way, inventory data represented in both merchant IM&A system 106 and supplier IM&A system 107 may be reconciled against data captured by and stored by Bizzap server 105. Also, returned goods designated for scrap by the retailer may be disputed by the supplier based on digital pictures and other return good transaction data managed by the Bizzap server 105. Or, in some embodiments, returned goods previously designated for scrap by the supplier based on digital pictures and other return good transaction data managed by the Bizzap server 105 may be indisputable. Resulting from the returned goods reconciliation aspect, embodiments of the system and method may be able to provide both the supplier and the retailer with an accurate and fair accounting of chargebacks.

The FIG. 1B is a functional block diagram illustrating exemplary components of a system 100B for managing returned goods 102 from a customer location 145, as opposed to the retail location 135 of FIG. 1A. The system 100B is similar to the system 100A, with the exception that the returned good transaction may be handled via a customer PCD 110B in communication directly with the supplier via the Bizzap server 105. The returned good 102, such as a bicycle with a bent handlebar, may be captured in a digital picture documenting the damage using the customer PCD 110B and RGDM module 212B. The customer PCD 110B may transmit the digital picture and proof of purchase 103 data via network 130 to Bizzap server 105. The RGDM module 212B may work with the RGDM module 212C to document the returned good transaction in the database 120. The supplier may then work through the Bizzap server 105 to coordinate a repair or replacement of the damaged item.

Turning to the FIG. 1 illustrations, exemplary embodiments of a PCD 110 envision remote communication, real-time software updates, extended data storage, etc. and may be leveraged in various configurations by users of system 100. Advantageously, embodiments of PCDs 110 configured for communication via a computer system such as the exemplary system 100 depicted in the FIG. 1 illustrations may leverage communications networks 130 including, but not limited to cellular networks, PSTNs, cable networks and the Internet for, among other things, software upgrades, content updates, database queries, data transmission, etc. Other data that may be used in connection with a PCD 110, and accessible via the Internet or other networked system, will occur to one of ordinary skill in the art.

The illustrated computer system 100 may comprise a Bizzap server 105, supplier and merchant backend server systems (such as may comprise IM&A systems 106, 107) that may be coupled to a network 130 comprising any or all of a wide area network (“WAN”), a local area network (“LAN”), the Internet, or a combination of other types of networks.

It should be understood that the term server may refer to a single server system or multiple systems or multiple servers. One of ordinary skill in the art will appreciate that various server arrangements may be selected depending upon computer architecture design constraints and without departing from the scope of the invention. The Bizzap server 105, in particular, may be coupled to a RGD and Customer Relationship database 120. The database 120 may store various records related to, but not limited to, PCD user-specific contact or account information, historical content, purchase transaction data, return good transaction data including digital pictures and/or videos of returned goods, supplier specific information, retailer specific information, inventory levels, accounts receivable data, repair work in progress, filters/rules algorithms for designating a scrap or repair status, survey content, previously recorded feedback, etc.

When a server in system 100, such as but not limited to a Bizzap server 105, is coupled to the network 130, the server may communicate through the network 130 with various different PCDs 110 associated with customers and/or retailers. Each PCD 110 may run or execute web browsing software or functionality to access the server and its various applications including RGDM module 212B. Any device that may access the network 130 either directly or via a tether to a complimentary device, may be a PCD 110 according to the computer system 100.

The PCDs 110, as well as other components within system 100 such as, but not limited to, a wireless router (not shown), may be coupled to the network 130 by various types of communication links 145. These communication links 145 may comprise wired as well as wireless links which may be either uni-directional or bi-directional communication channels, as would be understood by one of ordinary skill in the art of networking.

A PCD 110 may include a display 232, a processor 224 and a communications module 216 that may include one or more of a wired and/or wireless communication hardware and a radio transceiver 217. It is envisioned that the display 232 may comprise any type of display device such as a liquid crystal display (“LCD”), a plasma display, an organic light-emitting diode (“OLED”) display, a touch activated display, a cathode ray tube (“CRT”) display, a brail display, an LED bank, and a segmented display. A PCD 110 may execute, run or interface to a multimedia platform that may be part of a plug-in for an Internet web browser.

The communications module 216 may comprise wireless communication hardware such as, but not limited to, a WiFi card or NFC card for interfacing with a digital rendering of returned good transaction data. Further, the communications module 216 may include a cellular radio transceiver to transmit returned good content as well as other information to exemplary Bizzap server 105, as depicted in the system 100 embodiment. One of ordinary skill in the art will recognize that a communications module 216 may include application program interfaces to processor 224.

It is envisioned that a PCD 110 may be configured to leverage the cellular radio transceiver of the communications module 216 to transmit data, such as a returned good content by way of a secure channel using a wireless link 145 to the Bizzzap server 105. It is also envisioned that a PCD 110A in some exemplary embodiments of system 100 may established a communication between the POS 125 and PCD 110A to transmit data to and from Bizzap server 105.

Communication links 145, in general, may comprise any combination of wireless and wired links including, but not limited to, any combination of radio-frequency (“RF”) links, infrared links, acoustic links, other wireless mediums, wide area networks (“WAN”), local area networks (“LAN”), the Internet, a Public Switched Telephony Network (“PSTN”), and a paging network.

An exemplary PCD 110 may also comprise a computer readable storage/memory component 219 (shown in FIG. 2) for storing, whether temporarily or permanently, various data including, but not limited to, returned goods content. The memory 219 may include instructions for executing one or more of the method steps described herein. Further, the processor 224 and the memory 219 may serve as a means for executing one or more of the method steps described herein. Data added to, extracted or derived from the returned goods content may comprise a consumer ID, a transaction ID, a digital picture or video content, a QR code, a directory number (“DN”) or calling line ID (“CLID”) associated with PCD 110, a retailer ID, a hash value, a codec key, encryption or decryption data, account numbers and other account related data, etc.

FIG. 2 is a diagram of an exemplary, non-limiting aspect of a portable computing device (“PCD”) comprising a wireless tablet or telephone that corresponds with FIG. 1. As shown, the PCD 110 includes an on-chip system 222 that includes a digital signal processor 224 and an analog signal processor 226 that are coupled together. As illustrated in FIG. 2, a display controller 228 and a touchscreen controller 230 are coupled to the digital signal processor 224. A touchscreen display 232 external to the on-chip system 222 is coupled to the display controller 228 and the touchscreen controller 230.

FIG. 2 further indicates that a video encoder 234, e.g., a phase-alternating line (“PAL”) encoder, a sequential couleur avec memoire (“SECAM”) encoder, a national television system(s) committee (“NTSC”) encoder or any other video encoder, is coupled to the digital signal processor 224. Further, a video amplifier 236 is coupled to the video encoder 234 and the touchscreen display 232. A video port 238 is coupled to the video amplifier 236. A universal serial bus (“USB”) controller 240 is coupled to the digital signal processor 224. Also, a USB port 242 is coupled to the USB controller 240. A memory 219 and a subscriber identity module (“SIM”) card 246 may also be coupled to the digital signal processor 224. Further, a digital camera 248 may be coupled to the digital signal processor 224 and the RGDM module 212. In an exemplary aspect, the digital camera 248 is a charge-coupled device (“CCD”) camera or a complementary metal-oxide semiconductor (“CMOS”) camera.

As further illustrated in FIG. 2, a stereo audio CODEC 250 may be coupled to the analog signal processor 226. Moreover, an audio amplifier 252 may be coupled to the stereo audio CODEC 250. In an exemplary aspect, a first stereo speaker 254 and a second stereo speaker 256 are coupled to the audio amplifier 252. FIG. 2 shows that a microphone amplifier 258 may be also coupled to the stereo audio CODEC 250. Additionally, a microphone 260 may be coupled to the microphone amplifier 258. In a particular aspect, a frequency modulation (“FM”) radio tuner 262 may be coupled to the stereo audio CODEC 250. Also, an FM antenna 264 is coupled to the FM radio tuner 262. Further, stereo headphones 268 may be coupled to the stereo audio CODEC 250.

FIG. 2 further indicates that a radio frequency (“RF”) transceiver 217 may be coupled to the analog signal processor 226. An RF switch 270 may be coupled to the RF transceiver 217 and an RF antenna 272. As shown in FIG. 2, a keypad 274 may be coupled to the analog signal processor 226. Also, a mono headset with a microphone 276 may be coupled to the analog signal processor 226.

Further, a vibrator device 278 may be coupled to the analog signal processor 226. Also shown is that a power supply 280 may be coupled to the on-chip system 222. In a particular aspect, the power supply 280 is a direct current (“DC”) power supply that provides power to the various components of the PCD 110 that require power. Further, in a particular aspect, the power supply is a rechargeable DC battery or a DC power supply that is derived from an alternating current (“AC”) to DC transformer that is connected to an AC power source.

FIG. 2 also shows that the PCD 110 may include RGDM module 212 and a communications module 216. As described above, the RGDM module 212 may be operable work with the RF antenna 272 and transceiver 217 to establish communication with another PCD 110 or server or backend system (such as one or more of IM&A system 106, POS 125, etc.) and send a returned good content via a Bizzap server 105.

As depicted in FIG. 2, the touchscreen display 232, the video port 238, the USB port 242, the camera 248, the first stereo speaker 254, the second stereo speaker 256, the microphone 260, the FM antenna 264, the stereo headphones 268, the RF switch 270, the RF antenna 272, the keypad 274, the mono headset 276, the vibrator 278, and the power supply 280 are external to the on-chip system 222.

In a particular aspect, one or more of the method steps described herein may be stored in the memory 219 as computer program instructions. These instructions may be executed by the digital signal processor 224, the analog signal processor 226 or another processor, to perform the methods described herein. Further, the processors, 224, 226, the memory 219, the instructions stored therein, or a combination thereof may serve as a means for performing one or more of the method steps described herein.

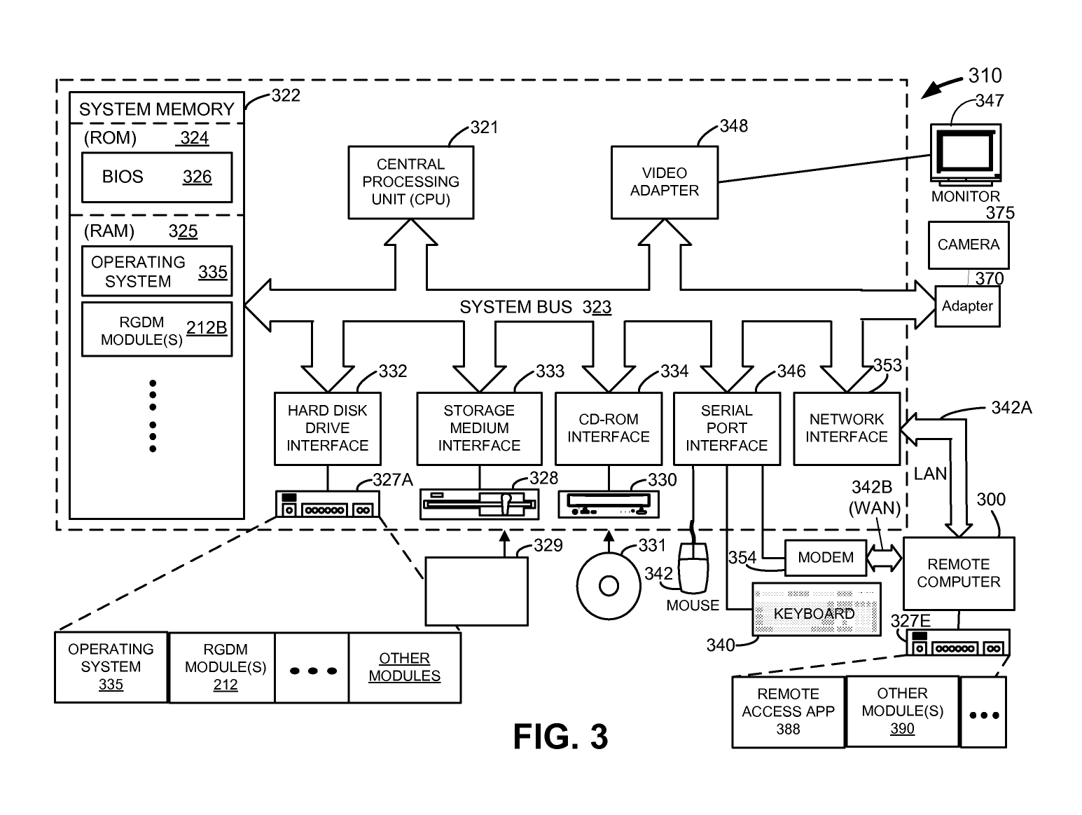

FIG. 3 is a functional block diagram of a general purpose computer 310 that may form at least one of the merchant inventory management and accounting system 106, supplier inventory management and accounting system 107, and Bizzap server 105 illustrated in FIG. 1. Generally, a computer 310 includes a central processing unit 321, a system memory 322, and a system bus 323 that couples various system components including the system memory 322 to the processing unit 321.

The system bus 323 may be any of several types of bus structures including a memory bus or memory controller, a peripheral bus, and a local bus using any of a variety of bus architectures. The system memory includes a read-only memory (ROM) 324 and a random access memory (RAM) 325. A basic input/output system (BIOS) 326, containing the basic routines that help to transfer information between elements within computer 310 such as during start-up, is stored in ROM 324.

The computer 310 may include a hard disk drive 327A for reading from and writing to a hard disk, not shown, a memory card drive 328 for reading from or writing to a removable memory card 329, and/or an optional optical disk drive 330 for reading from or writing to a removable optical disk 331 such as a CD-ROM or other optical media. Hard disk drive 327A and the memory card drive 328 are connected to system bus 323 by a hard disk drive interface 332 and a memory card drive interface 333, respectively.

Although the exemplary environment described herein employs hard disk 327A and the removable memory card 329, it should be appreciated by one of ordinary skill in the art that other types of computer readable media which may store data that is accessible by a computer, such as magnetic cassettes, flash memory cards, digital video disks, Bernoulli cartridges, RAMs, ROMs, and the like, may also be used in the exemplary operating environment without departing from the scope of the invention. Such uses of other forms of computer readable media besides the hardware illustrated may be used in internet connected devices such as in portable computing devices (“PCDs”) 110 that may include personal digital assistants (“PDAs”), mobile phones, tablet portable computing devices, and the like.

The drives and their associated computer readable media illustrated in FIG. 3 provide nonvolatile storage of computer-executable instructions, data structures, program modules, and other data for computer 310. A number of program modules may be stored on hard disk 327, memory card 329, optical disk 331, ROM 324, or RAM 325, including, but not limited to, an operating system 335 and RGDM modules 212B. Consistent with that which is defined above, program modules include routines, sub-routines, programs, objects, components, data structures, etc., which perform particular tasks or implement particular abstract data types.

A user may enter commands and information into computer 310 through input devices, such as a keyboard 340 and a pointing device 342. Pointing devices 342 may include a mouse, a trackball, and an electronic pen that may be used in conjunction with a tablet portable computing device. Other input devices (not shown) may include a microphone, joystick, game pad, satellite dish, scanner, or the like. These and other input devices are often connected to processing unit 321 through a serial port interface 346 that is coupled to the system bus 323, but may be connected by other interfaces, such as a parallel port, game port, a universal serial bus (USB), or the like.

The display 347 may also be connected to system bus 323 via an interface, such as a video adapter 348. The display 347 may comprise any type of display devices such as a liquid crystal display (LCD), a plasma display, an organic light-emitting diode (OLED) display, and a cathode ray tube (CRT) display.

A camera 375 may also be connected to system bus 323 via an interface, such as an adapter 370. The camera 375 may comprise a video camera such as a webcam. The camera 375 may be a CCD (charge-coupled device) camera or a CMOS (complementary metal-oxide-semiconductor) camera. In addition to the monitor 347 and camera 375, the computer 310 may include other peripheral output devices (not shown), such as speakers and printers.

The computer 310 may operate in a networked environment using logical connections to one or more remote computers such as the portable computing device(s) 110 illustrated in FIG. 1. The logical connections depicted in the FIG. 3 include a local area network (LAN) 342A and a wide area network (WAN) 342B, as illustrated more broadly in FIG. 1 as communications network 130. Such networking environments are commonplace in offices, enterprise-wide computer networks, intranets, and the Internet. When used in a LAN networking environment, the computer 310 is often connected to the local area network 342A through a network interface or adapter 353. The network interface adapter 353 may comprise a wireless communications and therefore, it may employ an antenna (not illustrated).

When used in a WAN networking environment, the computer 310 typically includes a modem 354 or other means for establishing communications over WAN 342B, such as the Internet. Modem 354, which may be internal or external, is connected to system bus 323 via serial port interface 346.

In a networked environment, program modules depicted relative to the remote portable computing device(s) 110, or portions thereof, may be stored in the remote memory storage device 327E (such as RGDM module 212B). A portable computing device 110 may execute a remote access program module for accessing data and exchanging data with RGDM modules 212B running on the computer 310.

Those skilled in the art may appreciate that the present solution for returned goods management may be implemented in other computer system configurations, including hand-held devices, multiprocessor systems, microprocessor based or programmable consumer electronics, network personal computers, minicomputers, mainframe computers, and the like. Embodiments of the solution may also be practiced in distributed computing environments, where tasks are performed by remote processing devices that are linked through a communications network, such as network 130. In a distributed computing environment, program modules may be located in both local and remote memory storage devices, as would be understood by one of ordinary skill in the art.

In one or more exemplary aspects, the functions described may be implemented in hardware, software, firmware, or any combination thereof. If implemented in software, the functions may be stored on or transmitted as one or more instructions or code on a computer-readable media. Computer-readable media include both computer storage media and communication media including any device that facilitates transfer of a computer program from one place to another.

A storage media may be any available media that may be accessed by a computer. By way of example, and not limitation, such computer-readable non-transitory media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of non-transitory computer-readable media.

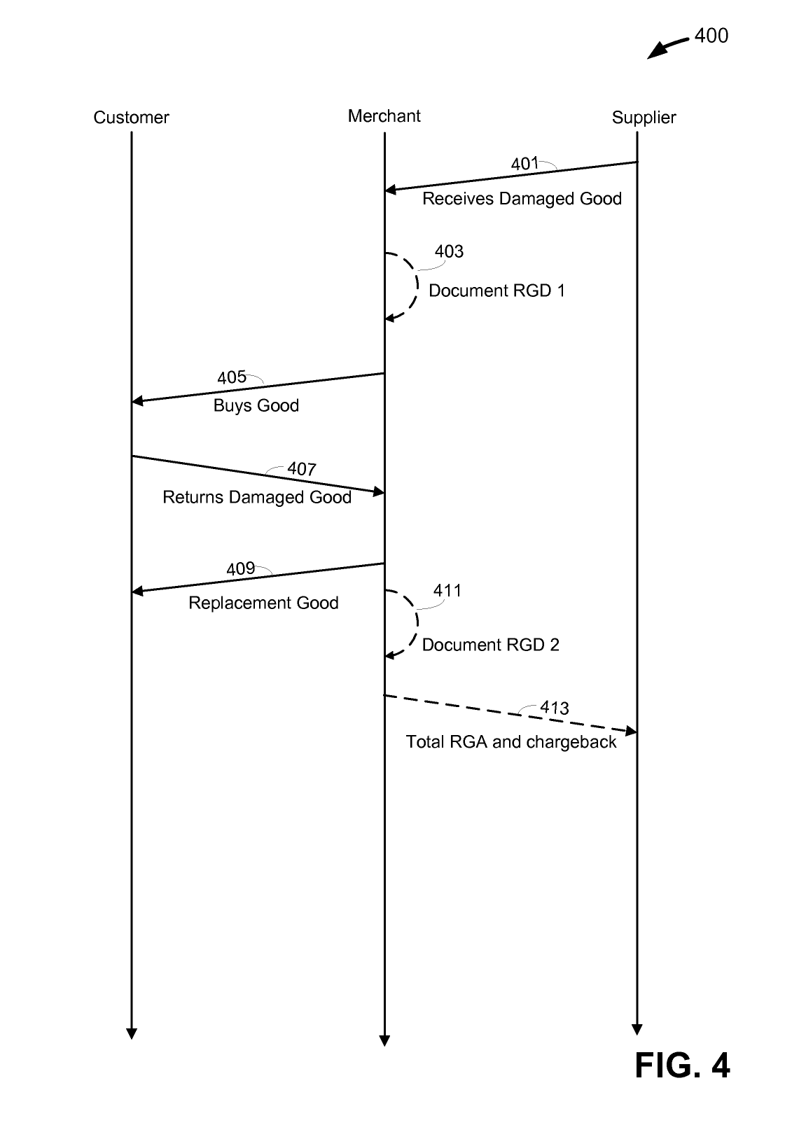

FIG. 4 is a product and communications flow diagram associated with a prior art system and method for management of returned goods. As described above, employees and retailers using prior art systems for returned goods management, such as that illustrated in FIG. 4, often find it more efficient to simply discard or scrap defective product than to coordinate for returning the product back to the manufacturer, especially in light of the ability to negotiate the discarded product in a chargeback at the end of a sales process. Moreover, retailers often have to cannibalize other products at the store to repair returned goods for customers, thereby rendering the cannibalized product unavailable to sell. The result of these shortcomings in the prior art is that manufacturers are charged back for products that could have been easily fixed with a replacement part sent to the store or customer. There is also no “true” data trail in the prior art systems and methods documenting what happened to a returned product, and so end of year chargebacks are often contentious negations between a manufacturer and retailer.

Consider the FIG. 4 product and communications flow diagram 400, for example, where the solid arrows indicate movement of a product and the dashed arrows indicate communication of data. Beginning at step 401, the supplier ships a product to a merchant, such as a bicycle. The product is received by the merchant and placed into inventory. As would be understood by one of ordinary skill in the art, the merchant may have paid the supplier for the product with the intention of placing the product on sale to the consuming public. If the product is discovered to be damaged, such as the bicycle with a bent handlebar, the merchant documents the product as a damaged good (i.e., a returned good) at step 403. Notably, the merchant may simply discard the bicycle or allow it to “find its way home” with an employee. At any rate, whether the damaged good is returned to the supplier or earmarked for repair is at the discretion of the merchant and/or an employee of the merchant. The supplier, of course, may be charged back for the entire value of the product because the product was not sold to a consumer.

Moving to step 405, a damaged good may be sold to a customer of the merchant. At step 407, the customer may return the damaged good to the merchant as he has no other remedy. The merchant, in an effort to provide quality customer service, may give the customer a replacement product at step 409 and discard the damaged product. The damaged product, which may have been easily fixed if the supplier were in the loop, or may have at least presented to the supplier a problem to avoid with future product, may be discarded by the merchant and documented at step 411 as a returned good. At the end of the sales cycle, the merchant may provide at step 413 a total chargeback amount to the supplier for the discarded goods. The supplier, absent any opportunity throughout the sales cycle to verify the nature of the damaged goods and remedy the damaged goods, is unable to mitigate its chargeback obligations to the merchant.

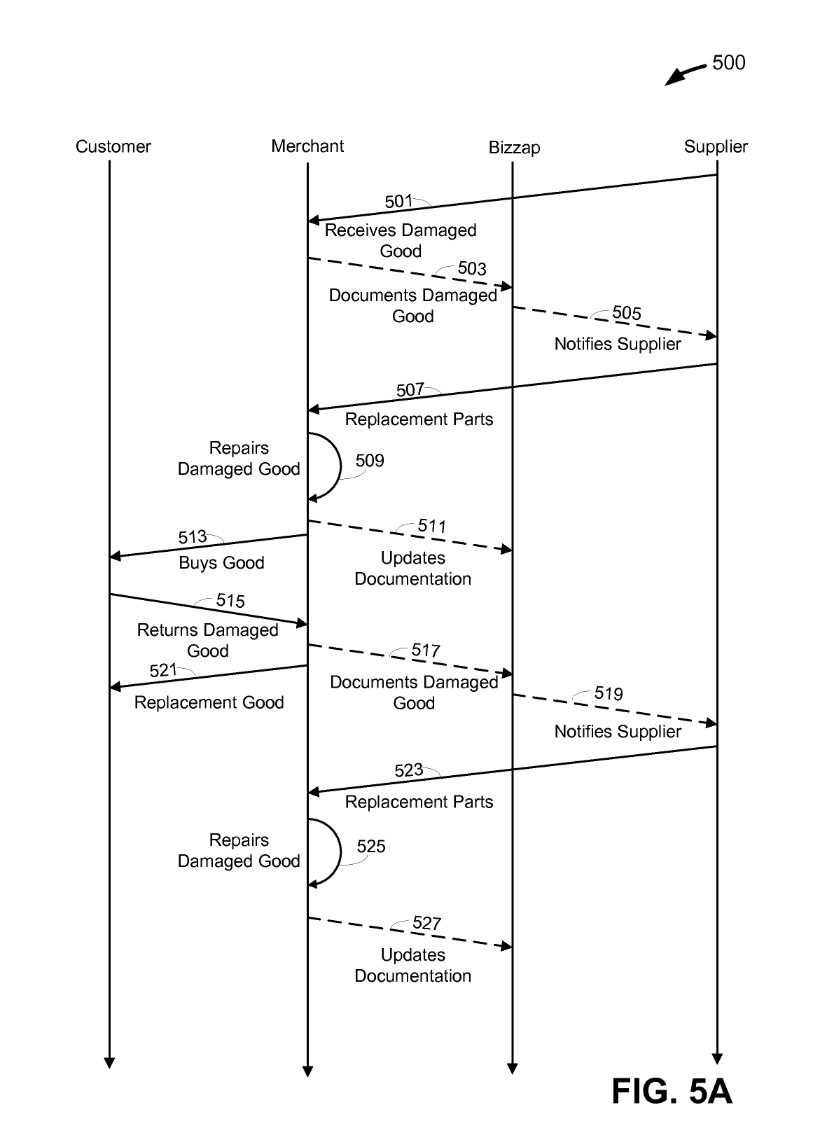

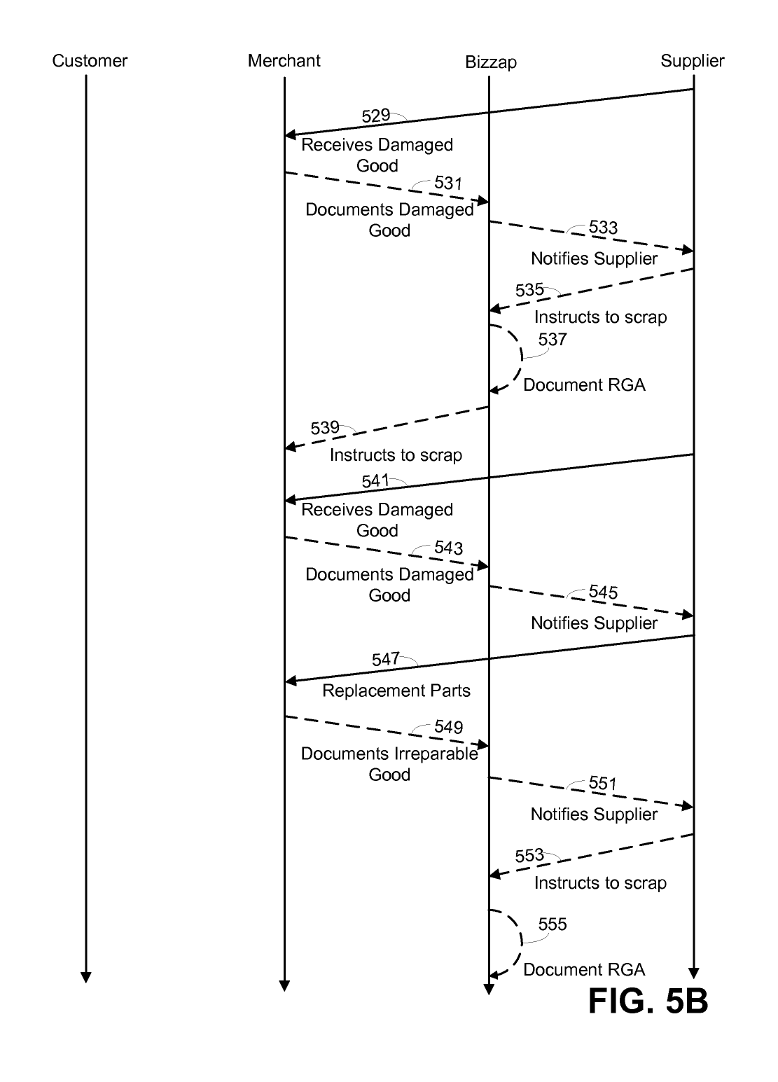

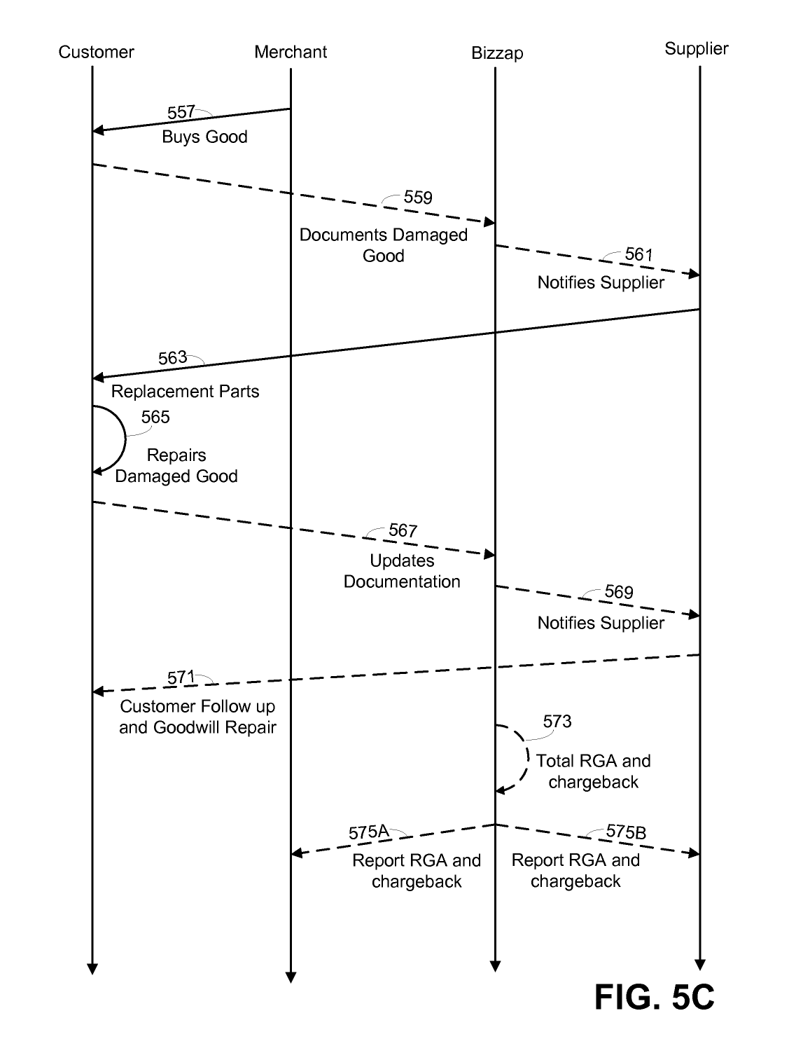

FIGS. 5A-5C is a product and communications flow diagram illustrating various aspects of a system and method for management of returned goods according to an exemplary embodiment of the solution. In the FIG. 5 product and communications flow diagram 500, the solid arrows indicate movement of a product and the dashed arrows indicate communication of data.

Beginning at step 501, the supplier may ship a damaged product to a merchant. Using a PCD 110 that may be a part of the merchant POS 125, the merchant may communicate with a Bizzap server at step 503 to document the damaged goods. As explained above, any amount of returned goods content may form the documentation including a digital picture of the damaged goods, the model and type of goods, shipping information, purchase order information, serial numbers, etc. At step 505, the Bizzap server 105 may communicate with the supplier, such as via the supplier IM&A system 107, to make the buyer aware of the damaged good.

In the event that the damaged good is deemed repairable, at step 507 the supplier may provide the merchant with a repair part. Notably, the Bizzap server 105 and, by extension the RGD and Customer Relationship database 120, may be updated to reflect that the replacement parts have been shipped from the supplier, the nature of the parts, associated repair instructions, etc. It will be understood that every step explicitly and inherently described herein may be documented by the Bizzap server 105 even if such is not depicted in the figures or mentioned in this description.

Returning to the FIG. 5 illustration, at step 509 the merchant may repair the goods and place them into inventory, thereby avoiding a scrap event or chargeback for the full value of the product. At step 511, the merchant may update the Bizzap server 105 to reflect that the damaged good has been repaired.

Beginning at step 513, a good may be purchased from the merchant by a customer. The customer may later discover that the good is damaged and elect to return the damaged good to the merchant at step 515. Similar to that which has been described above, the merchant may leverage the PCD 110A to document the nature of the returned good and the returned good transaction and update the Bizzap server 105 at step 517. The Bizzap server 105 then notifies the supplier at step 519. The supplier may subsequently determine that the returned good is repairable and should not be scrapped. At step 523 the supplier may provide the merchant with repair parts to repair the returned good. At step 525, the merchant may repair the returned good and place it back in inventory or return it to the customer. At step 527, the merchant may update the Bizzap server 105.

Turning now to steps 529 through 539 of FIG. 5B, dispensation instructions provided through a Bizzap based solution may require scrapping of a damaged or returned good not economically repairable. Beginning at step 529, a merchant may ship a damaged product to a merchant. Recognizing that the product is damaged, the merchant may leverage the PCD 110A to interface with the Bizzap server 105 and provide documentation of the damaged product at step 531. At step 533 the supplier is notified and, at step 535, elects to scrap the damaged product. At step 537 the Bizzap server 105 updates the database 120 to reflect that the product was damaged beyond repair and should be charged back to the supplier at the end of the sales cycle. At step 539, the merchant receives instructions to scrap the item.

Turning now to steps 541 through 555, dispensation instructions provided through a Bizzap based solution may require repair of a damaged item that proves irreparable. Beginning at step 541, a merchant may ship a damaged product to a merchant. Recognizing that the product is damaged, the merchant may leverage the PCD 110A to interface with the Bizzap server 105 and provide documentation of the damaged product at step 543. At step 545 the supplier is notified and, at step 547, ships repair parts to repair the damaged product. At step 549, the merchant may determine that the product cannot be repaired and updates the Bizzap server 105 accordingly. The supplier is notified at step 551 and, at step 553, elects to scrap the damaged product. At step 555 the Bizzap server 105 updates the database 120 to reflect that the product was damaged beyond repair and should be charged back to the supplier at the end of the sales cycle.

Turning now to steps 557 through 571 of FIG. 5C, a supplier may leverage a Bizzap based solution to directly interface with a customer for repair of a damaged product. Beginning at step 557, the customer may purchase a good that it later determines is damaged. Using a PCD 110B configured with a RGDM module, the customer may document to the Bizzap sever 105 the damaged good along with any required returned good content at step 559. The supplier may be notified of the damaged good and return request at step 561. Subsequently, at step 563 the supplier may provide the customer with repair parts. At step 565, the customer may repair the product, thereby avoiding the need to return the entire good to the supplier. At step 567, the Bizzap server 105 may be updated that the previously damaged product is repaired to the satisfaction of the customer. At step 569, the supplier may be updated as to the status of the product. At step 571, using the returned good content collected by the Bizzap server 105 and stored in the database 120, the supplier may reach out to the customer in an effort to repair and damaged goodwill. For example, the supplier may provide the customer with a discount on a future purchase.

At step 573, the total chargeback for a sales cycle, whether such chargeback is attributable to scrapped items, merchant labor associating with repairing damaged items, etc., may be calculated by the Bizzap server 105 and provided to the supplier and merchant at step 575. Notably, it should be understood that any data collected over the sales cycle and aggregated by the Bizzap server 105 may be provided to the supplier and/or merchant. Such data may include, but is not limited to including, customer information, product return rates, repair lead times, etc.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Also, in some instances, multiple actions depicted and described as unique steps in the present disclosure may be comprised within a single step. Further, words such as “thereafter”, “then”, “next”, “subsequently”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The functionality of the claimed computer implemented processes is explained in more detail in the above description and in conjunction with the Figures which may illustrate various process flows.

Therefore, although selected aspects have been illustrated and described in detail, it will be understood that various substitutions and alterations may be made therein without departing from the spirit and scope of the present invention, as defined by the following claims.

What is claimed is:

1. A method for centralized management of returned goods transactions, comprising:
receiving a returned good content, wherein the returned good content comprises a picture of a returned good;
determining from the returned good content that the returned good is repairable;
determining a parts list for repairing the returned good;
transmitting instructions to repair the returned good, wherein the instructions comprise the parts list; and
updating a returned goods database to reflect that the returned good was repaired.

2. The method of claim 1, wherein the returned good content further comprises data associated with a receipt for purchase of the returned good.

3. The method of claim 1, wherein the returned good content further comprises a request for a returned goods authorization.

4. The method of claim 1, further comprising:
receiving a second returned good content, wherein the second returned good content comprises a picture of a second returned good;
determining from the second returned good content that the second returned good should be scrapped;
transmitting instructions to scrap the second returned good; and
updating a returned goods database to reflect that the second returned good was scrapped.

5. The method of claim 4, further comprising:
generating a returned goods report, wherein the returned goods report indicates a chargeback amount owed a retailer for losses associated with returned goods over a period of time; and
transmitting the returns good report to a supplier and the retailer.

6. The method of claim 1, further comprising:
generating a shipping label in association with parts identified in the parts list.

7. The method of claim 1, wherein the returned good content is received from a retailer.

8. A system for centralized management of returned goods transactions, comprising:
a Bizzap server that comprises a returned goods management (“RGDM”) module configured to:
receive a returned good content, wherein the returned good content comprises a picture of a returned good;
determine from the returned good content that the returned good is repairable;
determine a parts list for repairing the returned good;
transmit instructions to repair the returned good, wherein the instructions comprise the parts list; and
update a returned goods database to reflect that the returned good was repaired.

9. The system of claim 8, wherein the returned good content further comprises data associated with a receipt for purchase of the returned good.

10. The system of claim 8, wherein the returned good content further comprises a request for a returned goods authorization.

11. The system of claim 8, the RGDM module further configured to:
receive a second returned good content, wherein the second returned good content comprises a picture of a second returned good;
determine from the second returned good content that the second returned good should be scrapped;
transmit instructions to scrap the second returned good; and
update a returned goods database to reflect that the second returned good was scrapped.

12. The system of claim 11, the RGDM module further configured to:
generate a returned goods report, wherein the returned goods report indicates a chargeback amount owed a retailer for losses associated with returned goods over a period of time; and
transmit the returns good report to a supplier and the retailer.

13. The system of claim 8, the RGDM module further configured to:
generate a shipping label in association with parts identified in the parts list.

14. The system of claim 8, wherein the returned good content is received from a retailer.

15. A computer program product comprising a computer usable device having a computer readable program code embodied therein, said computer readable program code executable to implement a method for centralized management of returned goods transactions, comprising:
receiving a returned good content, wherein the returned good content comprises a picture of a returned good;
determining from the returned good content that the returned good is repairable;
determining a parts list for repairing the returned good;
transmitting instructions to repair the returned good, wherein the instructions comprise the parts list; and
updating a returned goods database to reflect that the returned good was repaired.

16. The computer program product of claim 15, wherein the returned good content further comprises data associated with a receipt for purchase of the returned good.

17. The computer program product of claim 15, wherein the returned good content further comprises a request for a returned goods authorization.

18. The computer program product of claim 15, further comprising:
receiving a second returned good content, wherein the second returned good content comprises a picture of a second returned good;
determining from the second returned good content that the second returned good should be scrapped;
transmitting instructions to scrap the second returned good; and
updating a returned goods database to reflect that the second returned good was scrapped.

19. The computer program product of claim 18, further comprising:
generating a returned goods report, wherein the returned goods report indicates a chargeback amount owed a retailer for losses associated with returned goods over a period of time; and
transmitting the returns good report to a supplier and the retailer.

20. The computer program product of claim 15, further comprising:
generating a shipping label in association with parts identified in the parts list.
